(19) United States
(12) Patent Application Publication
(10) Pub. No.: US 2012/0320314 A1
(43) Pub. Date: Dec. 20, 2012

(54) LIQUID CRYSTAL DISPLAY

(76) Inventors: Hsien-Kuang LIN, Hsinchu City (TW); Kuo-Tung HUANG, Zhudong Township (TW); Sue-May CHEN, Taipei City (TW); Wei-Chi WANG, Banqiao City (TW); Jauder JENG, Taichung City (TW)

(21) Appl. No.: 13/492,436

(22) Filed: Jun. 8, 2012

(30) Foreign Application Priority Data
Jun. 17, 2011 (TW) 100121166

(51) Int. Cl. G02F 1/1335

(52) U.S. Cl. 349/96

(57) ABSTRACT

The invention provides a liquid crystal display, which includes an LCD panel and a first polarizing film and a second polarizing film respectively formed on the two sides of the LCD panel, wherein the first polarizing film is directly formed on the LCD panel, and the first polarizing film and a second polarizing film respectively includes a polarizer and a first pressure sensitive adhesive (PSA) and a second PSA formed on the two sides of the polarizer, wherein the first PSA is closer to the LCD panel than the second PSA, and the first PSA of the first polarizing film is directly formed on the LCD panel.

### CROSS REFERENCE TO RELATED APPLICATIONS

This application claims priority of Taiwan Patent Application No. 100121166, filed on Jun. 17, 2011, the entirety of which is incorporated by reference herein.

### BACKGROUND OF THE INVENTION

1. Field of the Invention

The present invention relates to an ultra-thin polarizing film, and in particular relates to a liquid crystal display with the ultra-thin polarizing film.

2. Description of the Related Art

Liquid crystal displays are widely used in electronic devices, comprises TVs, mobile phones or notebooks, due to their small sizes, light weights, low driving voltages and low power consumption.

A conventionally liquid crystal display comprises a TFT substrate and a color filter substrate, and a liquid crystal layer formed between the TFT substrate and the color filter substrate, and a polarizing film is often adhered on the outer surfaces of the TFT substrate and the color filter substrate.

The function of the polarizing film is to change the polarization state of light. The structure of the conventional polarizing film of the liquid crystal display is made by several layers comprising: a pressure sensitive adhesive/tri-acetyl cellulose (TAC) protective layer, PVA adhesive layer, PVA polarizer layer, PVA adhesive layer, TAC protective layer, and pressure sensitive adhesive layer. However, the fabrication method of the conventional polarizing film is tedious and the overall thickness is about 150-200 μm which is too thick for roll-to-roll processes.

Therefore, there is a need to develop a polarizing film with reduced thickness for roll-to-roll processes.

### BRIEF SUMMARY OF THE INVENTION

The invention provides a liquid crystal display, which includes an LCD panel; and a first polarizing film and a second polarizing film respectively formed on the two sides of the LCD panel, wherein the first polarizing film is directly formed on the LCD panel, and the first polarizing film and a second polarizing film respectively include: a polarizer and a first pressure sensitive adhesive (PSA) and a second PSA respectively formed on the two sides of the polarizer, wherein the first PSA is closer to the LCD panel than the second PSA, and the first PSA of the first polarizing film is directly formed on the LCD panel.

A detailed description is given in the following embodiments with reference to the accompanying drawings.

### BRIEF DESCRIPTION OF THE DRAWING

For a more complete understanding of the present invention, and the advantages thereof, reference is now made to the following descriptions taken in conjunction with the accompanying drawings, in which:

FIG. 1 shows a cross-sectional schematic representation of a first embodiment in accordance with the invention;

FIG. 2 shows a cross-sectional schematic representation of a second embodiment in accordance with the invention; and

FIG. 3 shows a cross-sectional schematic representation of a third embodiment in accordance with the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

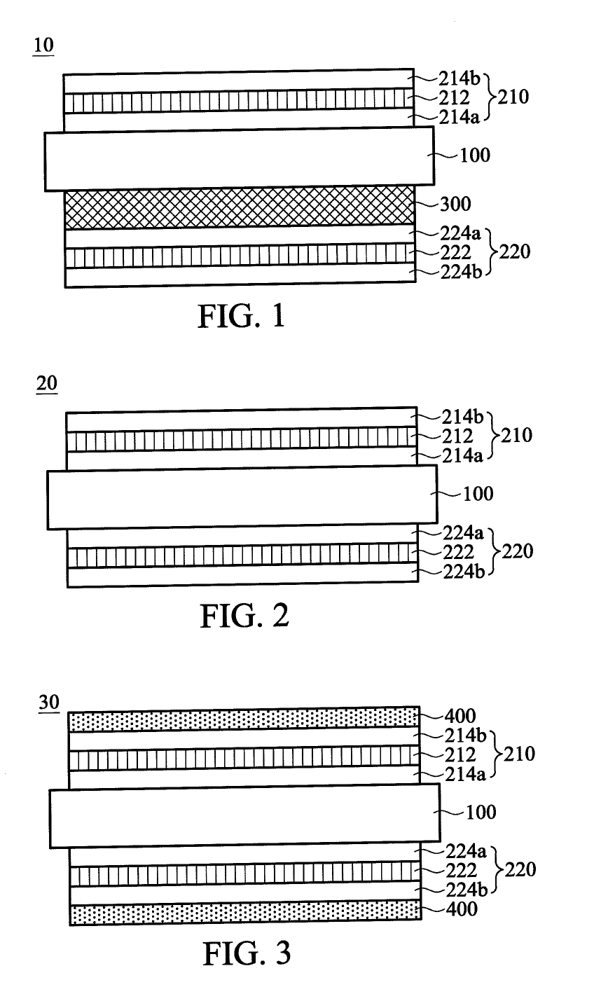

FIG. 1 shows a cross-sectional schematic representation of a liquid crystal display 10 in accordance with a first embodiment of the invention. The liquid crystal display 10 comprises an LCD panel 100 and a first polarizing film 210 and a second polarizing film 220 formed on two sides of the LCD panel 100. The LCD panel 100 essentially comprises a TFT substrate, a color filter substrate and a liquid crystal layer formed between the TFT substrate and the color filter substrate.

The first polarizing film 210 comprises a polarizer 212, a first pressure sensitive adhesive (PSA) 214a and a second pressure sensitive adhesive 214b. The first PSA 214a and the second PSA 214b are respectively formed on two sides of the polarizer 212, and the first PSA 214a is closer to the LCD panel 100 than the second PSA 214b.

The second polarizing film 220 comprises a polarizer 222, a first PSA 224a and a second PSA 224b. The first PSA 224a and the second PSA 224b are respectively formed on two sides of the polarizer 222, and the first PSA 224a is closer to the LCD panel 100 than the second PSA 224b.

Note that the first polarizing film 210 is directly formed on the LCD panel 100 and the first PSA 214a of the first polarizing film 210 is directly formed on the LCD panel 100.

Additionally, a phase retarder 300 is further disposed between the second polarizing film 220 and the LCD panel 100. The function of the phase retarder 300 is to convert the linearly polarized light into the circularly polarized light.

The polarizer 212, 222 comprises poly vinyl acetate (PVA) which has an average molecular weight of about 150,000-250,000, a hot water breaking temperature of about 60-70° C., and a thickness of about 20-40 μm, preferably 20-30 μm. The first PSA 214a and the second PSA 214b respectively have a thickness of about 20-40 μm, preferably 20-30 μm and respectively comprise a thermal curable pressure sensitive adhesive or UV curable pressure sensitive adhesive.

In one embodiment, the pressure sensitive adhesive of the invention is a thermal curable pressure sensitive adhesive which comprises a polymer binder and a thermal curable agent. Firstly, the acrylate monomers and initiator are polymerized to form a polymer binder with an average molecular weight of about 100,000-1,000,000. Then, a thermal curable agent is added into the polymer binder to form the pressure sensitive adhesive. The function of the thermal curable agent is to adjust the adhesion strength and cohesion of the pressure sensitive adhesive.

The acrylate monomers comprise methyl acrylate, methyl methacrylate, 2-hydroxyethyl acrylate, 2-hydroxyethyl methacrylate, 4-hydroxybutyl acrylate, cyclohexyl methacrylate, dodecyl acrylate, ethyl acrylate, 2-ethylhexyl acrylate, n-butyl acrylate or tert-butyl acrylate.

The thermal curable agent comprises polyisocyanates or methylated melamine resins.

The polyisocyanates may be formed by reacting diisocyanates with polyols. The diisocyanates comprises hexamethylene diisocyanate, isophorone diisocyanate, or toluene diisocyanate, etc., wherein hexamethylene diisocyanate and isophorone diisocyanate with aliphatic groups is preferred due to having the advantage of yellowing resistance. The polyols comprise short-chain polyols and long-chain polyols. The short-chain polyols comprises 1,4-butanediol, 1,2-propanediol or 1,6-hexandiol. The long-chain polyols comprises polypropylene glycol, polytetramethylene glycol, polyethylene glycol, polyester diols, polybutadiene diol, polydimethylsiloxane diol, polycarbonate diols or polycaprolactone diols.

The methylated melamine resins comprises product name Cymel 300, Cymel 301, Cymel 303, Cymel 325 or Cymel 370 (purchased from Cytec industries).

In one embodiment, the polymer binder of the invention is fabricated by a solution polymerization process. The solvent used in the solution polymerization process comprises methyl methacrylate, 2-hydroxyethyl acrylate, 2-hydroxyethyl methacrylate, 4-hydroxybutyl acrylate, cyclohexyl methacrylate, dodecyl acrylate, ethyl acrylate, tert-butyl acrylate or combinations thereof.

Note that during the solution polymerization process, those skilled in the art may choose one or more kinds of monomers to adjust the glass transition temperature (Tg) of the polymer bonder according to actual needs. In general, a higher hardness of the polymer binder is obtained when the polymer binder has a higher glass transition temperature (Tg).

In yet another embodiment, the pressure sensitive adhesive of the invention is a UV curable pressure sensitive adhesive which comprises a urethane acrylate oligomer, a UV curable unsaturated monomer and a photoinitiator. The urethane acrylate oligomer has a glass transition temperature (Tg) smaller than 10° C. to provide suitable adhesive strength of the pressure sensitive adhesive. The UV curable unsaturated monomer is used to provide suitable mechanical strength for the pressure sensitive adhesive.

The UV curable unsaturated monomer comprises phenoxyethyl acrylate, octyl acrylate, dodecyl acrylate, hexanediol diacrylate, tripropylene glycol diacrylate, trimethylolpropane triacrylate, ethoxylated trimethylolpropane triacrylate, trimethylolpropane trimethacrylate, ethoxylated trimethylolpropane trimethacrylate, pentaerythritol triacrylate, pentaerythritol trimethacrylate, pentaerythritol tetraacrylate, pentaerythritol tetramethacrylate, dipentaerythritol pentaacrylate or dipentaerythritol hexaacrylate. The UV curable unsaturated monomer may be used alone or mixed together, and the kind and addition of the UV curable unsaturated monomer is chosen depending on the hardness requirement of the UV curable pressure sensitive adhesive.

The photoinitiator comprises benzil dimethyl ketal, 2,4-diethylthioxanthone, isopropylthioxanthone, 2-methyl-1-(4-(methylthio) phenyl)-2-morpholinopropanone-1 or benzophenone. However, other photoinitiators having good photodegradation ability may also be included in the scope of the invention.

Additionally, a sensitizer may also be added into the pressure sensitive adhesive of the invention to improve the sensitivity of the pressure sensitive adhesive, and the sensitizer comprises the 2-dimethyl aminoethyl benzoate, ethyl(p-dimethylamino) benzoate) or michler's ketone.

Furthermore, other additives may be added into the first PSA 214a, 224a and the second PSA 214b, 224b, and they comprise leveling agents, surfactants, defoaming agents, antioxidants, plasticizers, etc.

In prior art, the structure of the conventional polarizing film of the liquid crystal display is: pressure sensitive adhesive/tri-acetyl cellulose (TAC) protective layer/PVA adhesive/PVA polarizer/PVA adhesive/TAC protective layer/pressure sensitive adhesive. In other words, when the PVA polarizer is as a symmetric center, the PVA adhesive, TAC protective layer and pressure sensitive adhesive are respectively formed on the two sides of the PVA polarizer. Compared with prior art, the glass transition temperature of the pressure sensitive adhesive of the invention is controlled by the choice of raw materials and is about −60° C.-10° C., preferably −40° C.-10° C. Thus, the pressure sensitive adhesive of the invention has proper adhesion (the adhesion strength between the glass and the pressure sensitive adhesive is about 20-200 g/25 mm). Additionally, the conventional three-layered structure (the PVA adhesive/TAC protective layer/pressure sensitive adhesive) is replaced by a single layer of the pressure sensitive adhesive of the invention, and therefore the overall thickness of the polarizing film is reduced to about 65-150 μm from 150-200 μm.

Moreover, FIG. 2 shows a cross-sectional schematic representation of a liquid crystal display 10 in accordance with a second embodiment of the invention, wherein like elements are identified by the same reference numbers as in FIG. 1, and thus omitted for brevity. The difference between the FIG. 1 and FIG. 2 is that the second polarizing film 220 is directly formed on the LCD panel 100 in FIG. 2. Thus, the first PSA 224a of the second polarizing film 220 is directly formed on the LCD panel 100. In other words, in FIG. 2, the first polarizing film 210 and the second polarizing film 220 are both directly formed on the LCD panel 100.

FIG. 3 shows a cross-sectional schematic representation of a liquid crystal display 10 in accordance with a third embodiment of the invention, wherein like elements are identified by the same reference numbers as in FIG. 1, and thus omitted for brevity. The difference between the FIG. 1 and FIG. 3 is that an additional hardcoat layer 400 is formed on the second PSA 214b, 224b in FIG. 3. The function of the hardcoat layer 400 is to protect and support the pressure sensitive adhesive. Note that in FIG. 3, the hardcoat layer 400 is formed on the first polarizing film 210 and the second polarizing film 220. Alternatively, the hardcoat layer 400 may be formed on the first polarizing film 210 or the second polarizing film 220.

The polarizing film of the invention is fabricated by the following steps. The pressure sensitive adhesive is formed firstly, and it is coated on the poly(ethylene terephthalate) (PET) film to form a two-layered structure (pressure sensitive adhesive/PET film).

Then, the two-layered structure is respectively adhered on two sides of the polarizer and the pressure sensitive adhesive is directly adhered to the polarizer to form a thin polarizing film.

Next, the two PET films are peeled off from the thin polarizing film and the thin polarizing film is directly adhered to a liquid crystal display to form the liquid crystal display with the thin polarizing film.

In another embodiment, a three-layered structure is formed. The material of the hardcoat layer is coated on the poly(ethylene terephthalate) (PET) film and irradiated by UV light to form a hardcoat. Then, the pressure sensitive adhesive is coated on the hardcoat layer and heated at 90-110° C. for 5-20 minutes to form the three-layered structure (pressure sensitive/hardcoat layer/PET film).

Then, the three-layered structure is respectively adhered on two sides of the polarizer and the pressure sensitive adhesive is directly adhered to the polarizer to form a thin polarizing film with a hardcoat layer.

Next, the two PET films are peeled off from the thin polarizing film and the thin polarizing film is directly adhered to a liquid crystal display to form the liquid crystal display with the thin polarizing film.

In yet another embodiment, the two-layered structure and three-layered structure are respectively adhered on two sides of the polarizer to form a thin polarizing film with a hardcoat layer on a single side.

The polarization coefficient of the liquid crystal display is calculated by detecting the transmittance at the perpendicular position (Tc) and the parallel position (Tp) in a wavelength range of about 400-700 nm. The data shows that the polarization coefficient of the liquid crystal display of the invention is about 98-100.07%. Additionally, the adhesion strength between the pressure sensitive adhesive of the invention and a glass is about 20-200 g/mm.

From the above description, the conventional three-layered structure (the PVA adhesive/TAC protective layer/pressure sensitive adhesive) is replaced by a single layer of the pressure sensitive adhesive of the invention, and the overall thickness of the polarizing film is reduced to about 65-150 μm. Therefore, the polarizing film of the invention is very promising for use in roll-to-roll processes.

### EXAMPLE

### Example 1

(1) The Material of a Hardcoat Layer

The components of Table 1, 5 phr of the photoinitiator (1-Hydroxy-cyclohexyl-phenyl-ketone (Ciba IRGACURE 184)), and 2 phr of surfactant (Silsurf®A004 (SILTECH CORPORATION)) were mixed together to form the material of the hardcoat layer.

TABLE 1

| components | ratio |
|---|---|
| Ethoxylated (3) Bisphenol A Diacrylate | 60 wt % |
| (AgiSyn ™ 2826 (BPA3EODA)) | |
| Ethoxylated (3) Trimethylolpropane | 20 wt % |
| Triacrylate (Cognis, PHOTOMER ® 4149) | |
| Tripropylene Glycol Diacrylate | 10 wt % |
| (TPGDA, Cognis, PHOTOMER ® 4061) | |
| Trifunctional aliphatic urethane | 10 wt % |
| acrylate blend (Cognis, PHOTOMER ® 6184) | |

(2) Fabrication of a Polymer Bander (I)

114.7 g of propylene glycol methyl ether acetate was added into a four-neck flask. The four-neck flask was filled with nitrogen gas and heated to 90° C.

75.1 g of 4-hydroxybutyl acrylate, 137.3 g of cyclohexyl methacrylate, 170.0 g of dodecyl acrylate, 267.7 g of propylene glycol methyl ether acetate and 0.38 g of N,N′-azobisisobutyronitrile were slowly dropped into the four-neck flask for 200 minutes. The mixture were reacted for 4 hours to obtain the polymer binder (I) (solid content: 50%; average molecular weight (Mw): 352,000)

(3) Fabrication of a Thermal Curable Pressure Sensitive Adhesive

The components as shown in Table 2 were mixed to obtain the thermal curable pressure sensitive adhesive.

TABLE 2

| components | Ratio (phr) |
|---|---|
| Polymer binder (I) | 200.0 |
| Dibutyltin dilaurate (as catalyst) | 0.2 |
| hexamethylene diisocyanate | 0.11 |
| (as curable agent) | |
| Bis(2-ethylhexyl)sebacate | 2.0 |
| Triphenyl phosphate | 1.5 |
| Modaflow 2100 (as leveling agent) | 1.0 |
| Defoamer DC-1000 (as defoaming agent) | 2.0 |
| Methyl ethyl ketone (as solvent) | 100.0 |

(4) Fabrication of a Three-Layered Structure

The material of the hardcoat layer was coated on the poly(ethylene terephthalate) (PET) film and irradiated by UV light to form a composite film (the hardcoat layer/PET film).

The thermal curable pressure sensitive adhesive was coated on the hardcoat layer of the composite film and heated at 100° C. for 10 minutes to form the three-layered structure (thermal curable pressure sensitive adhesive/hardcoat layer/PET film).

(5) Fabrication of a Two-Layered Structure

The thermal curable pressure sensitive adhesive was coated on the PET film and heated at 100° C. for 10 minutes to form the two-layered structure (thermal curable pressure sensitive adhesive/PET film).

(6) Fabrication of a Thin Polarizing Film

The two-layered structure and three-layered structure were respectively adhered on two sides of the PVA polarizer, wherein the pressure sensitive adhesive of the two-layered structure and the pressure sensitive adhesive of the three-layered structure were respectively and directly adhered to the PVA polarizer to form the thin polarizing film.

(7) Fabrication of a Liquid Crystal Display

The two PET films were peeled off from the thin polarizing film and the thin polarizing film was directly adhered to an LCD panel (such as glass) to form the liquid crystal display.

The polarization coefficient of the liquid crystal display of Example 1 was about 99.46-100.07%. The adhesion strength of the thermal curable pressure sensitive adhesive was about 27 g/25 mm.

### Example 2

The experimental condition of the Example 2 was the same as that of the Example 1, except that the fabrication method of the polymer binder was different.

The polymer binder of Example 2 was fabricated by the following steps.

68.2 g of propylene glycol methyl ether acetate was added into a four-neck flask. The four-neck flask was filled with nitrogen gas and heated to 90° C.

27.1 g of 2-hydroxyethyl methacrylate, 122.6 g of ethyl acrylate, 77.7 g of tert-butyl acrylate, 159.2 g of propylene glycol methyl ether acetate and 0.23 g of N,N′-azobisisobutyronitrile were slowly dropped into the four-neck flask for 200 minutes. The mixture was reacted for 4 hours to obtain the polymer binder (II) (solid content: 50%; average molecular weight (Mw): 538,000).

The polarization coefficient of the liquid crystal display of Example 2 was about 98.77-100.01%. The adhesion strength of the thermal curable pressure sensitive adhesive was about 57 g/25 mm.

### Example 3

The experimental condition of the Example 3 was the same as that of the Example 1, except that the fabrication methods of the hardcoat layer and the polymer binder were different.

(1) The Material of the Hardcoat Layer of Example 3 was Fabricated by the Following Steps.

The components of Table 3, 5 phr of the photoinitiator (1-Hydroxy-cyclohexyl-phenyl-ketone (Ciba IRGACURE 184)), and 2 phr of surfactant (Silsurf®A004 (SILTECH CORPORATION)) were mixed together to form the material of the hardcoat layer.

TABLE 3

| components | ratio |
|---|---|
| Ethoxylated (3) Bisphenol A Diacrylate | 40 wt % |
| (AgiSyn ™ 2826 (BPA3EODA)) | |
| Ethoxylated (3) Trimethylolpropane | 20 wt % |
| Triacrylate (Cognis, PHOTOMER ® 4149) | |
| Tripropylene Glycol Diacrylate | 10 wt % |
| (TPGDA, Cognis, PHOTOMER ® 4061) | |
| Trifunctional aliphatic urethane | 30 wt % |
| acrylate blend (Cognis, PHOTOMER ® 6184) | |

(2) The Polymer Binder (III) of Example 3 was Fabricated by the Following Steps.

61.8 g of propylene glycol methyl ether acetate was added into a four-neck flask. The four-neck flask was filled with nitrogen gas and heated to 90° C.

60.1 g of 4-hydroxybutyl acrylate, 105.4 g of methyl acrylate, 40.5 g of methyl methacrylate, 144.2 g of propylene glycol methyl ether acetate and 0.31 g of N,N′-azobisisobutyronitrile were slowly dropped into the four-neck flask for 200 minutes. The mixture was reacted for 4 hours to obtain the polymer binder (III) (solid content: 50%; average molecular weight (Mw): 436,000).

The polarization coefficient of the liquid crystal display of Example 3 was about 99.45-100.03%. The adhesion strength of the thermal curable pressure sensitive adhesive was about 71 g/25 mm.

### Example 4

The experimental condition of the Example 4 was the same as that of the Example 1, except that the fabrication method of the hardcoat layer was the same as that of the Example 3, and the fabrication method of the polymer binder was different.

The polymer binder (IV) of Example 4 was fabricated by the following steps.

94.2 g of propylene glycol methyl ether acetate was added into a four-neck flask. The four-neck flask was filled with nitrogen gas and heated to 90° C.

159.7 g of cyclohexyl methacrylate, 7.3 g of 2-hydroxyethyl acrylate, 147.1 g of 2-ethoxyethyl acrylate, 219.9 g of propylene glycol methyl ether acetate and 0.083 g of N,N′-azobisisobutyronitrile were slowly dropped into the four-neck flask for 200 minutes. The mixture was reacted for 4 hours to obtain the polymer binder (IV) (solid content: 50%; average molecular weight (Mw): 824,000).

The polarization coefficient of the liquid crystal display of Example 4 was about 98.82-99.998%. The adhesion strength of the thermal curable pressure sensitive adhesive was about 66 g/25 mm.

### Example 5

(1) The Fabrication Methods of the Hardcoat Layer and the Thermal Curable Pressure Sensitive Adhesive of the Example 5 were the Same as that of the Example 1,

(2) Fabrication of a UV Curable Pressure Sensitive Adhesive

The components as shown in Table 4 were mixed to form the UV curable pressure sensitive adhesive of Example 5.

TABLE 4

| components | ratio (phr) |
|---|---|
| Photomer 6184(urethane diacrylate, Henkel) | 50 |
| CN965NS (Urethane diacrylate, Sartomer) | 50 |
| Phenoxyethyl acrylate | 45 |
| Igacure 184 (Ciba) | 3 |
| Modaflow 2100 (as leveling agent) | 1.0 |

(3) The Three-Layered Structure of Example 5 was the Same that of Example 1.

(4) Fabrication of a Two-Layered Structure

The UV curable pressure sensitive adhesive was coated on the PET film and irradiated by UV light for 1 minute (exposure amount: 500 mJ/cm²) to form the two-layered structure (UV curable pressure sensitive adhesive/PET film).

(5) Fabrication of a Thin Polarizing Film

The two-layered structure and three-layered structure were respectively adhered on two sides of the PVA polarizer, wherein the UV curable pressure sensitive adhesive of the two-layered structure and the thermal curable pressure sensitive adhesive of the three-layered structure were respectively and directly adhered to the PVA polarizer to form the thin polarizing film.

(6) Fabrication of a Liquid Crystal Display

The two PET films were peeled off from the thin polarizing film and the thin polarizing film was directly adhered to a liquid crystal display (such as glass) to form the liquid crystal display.

The polarization coefficient of the liquid crystal display of Example 5 was about 99.46-100.07%. The adhesion strength of the thermal curable pressure sensitive adhesive was about 60 g/25 mm.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A liquid crystal display, comprising:
an LCD panel;
a first polarizing film and a second polarizing film respectively formed on two sides of the LCD panel, wherein the first polarizing film is directly formed on the LCD panel, and the first polarizing film and the second polarizing film respectively comprises:
a polarizer; and
a first pressure sensitive adhesive (PSA) and a second pressure sensitive adhesive respectively formed on two sides of the polarizer, wherein the first pressure sensitive adhesive is closer to the LCD panel than the second pressure sensitive adhesive and the first pressure sensitive adhesive of the first polarizing film is directly formed on the LCD panel.

2. The liquid crystal display as claimed in claim 1, wherein the second polarizing film is directly formed on the LCD panel and the first pressure sensitive adhesive of the second polarizing film is directly formed on the LCD panel.

3. The liquid crystal display as claimed in claim 1, further comprising a phase retarder formed between the second polarizing film and the LCD panel.

4. The liquid crystal display as claimed in claim 1, wherein the polarizer comprises poly vinyl acetate (PVA).

5. The liquid crystal display as claimed in claim 4, wherein the poly vinyl acetate (PVA) has an average molecular weight of about 150,000-250,000.

6. The liquid crystal display as claimed in claim 1, further comprising a hardcoat layer formed on the second pressure sensitive adhesive of the first polarizing film or on the second pressure sensitive adhesive of the second polarizing film.

7. The liquid crystal display as claimed in claim 1, wherein the first pressure sensitive adhesive and the second pressure sensitive adhesive respectively comprise a thermal curable pressure sensitive adhesive or a UV curable pressure sensitive adhesive.

8. The liquid crystal display as claimed in claim 7, wherein the thermal curable pressure sensitive adhesive comprises a polymer binder and a thermal curable agent.

9. The liquid crystal display as claimed in claim 8, wherein the polymer binder is formed from the acrylate monomers.

10. The liquid crystal display as claimed in claim 9, wherein the acrylate monomers comprise methyl acrylate, methyl methacrylate, 2-hydroxyethyl acrylate, 2-hydroxyethyl methacrylate, 4-hydroxybutyl acrylate, cyclohexyl methacrylate, dodecyl acrylate, ethyl acrylate, 2-ethylhexyl acrylate, n-butyl acrylate or tert-butyl acrylate.

11. The liquid crystal display as claimed in claim 8, the polymer binder has an average molecular weight of about 100,000-1,000,000.

12. The liquid crystal display as claimed in claim 8, wherein the thermal curable agent comprises polyisocyanates or methylated melamine resins.

13. The liquid crystal display as claimed in claim 7, wherein the UV curable pressure sensitive adhesive comprises a urethane acrylate oligomer, a UV curable unsaturated monomer and a photoinitiator.

14. The liquid crystal display as claimed in claim 13, wherein the UV curable unsaturated monomer comprises phenoxyethyl acrylate, octyl acrylate, dodecyl acrylate, hexanediol diacrylate, tripropylene glycol diacrylate, trimethylolpropane triacrylate, ethoxylated trimethylolpropane triacrylate, trimethylolpropane trimethacrylate, ethoxylated trimethylolpropane trimethacrylate, pentaerythritol triacrylate, pentaerythritol trimethacrylate, pentaerythritol tetraacrylate, pentaerythritol tetramethacrylate, dipentaerythritol pentaacrylate or dipentaerythritol hexaacrylate.

15. The liquid crystal display as claimed in claim 13, wherein the photoinitiator comprises benzil dimethyl ketal, 2,4-diethylthioxanthone, isopropylthioxanthone, 2-methyl-1-(4-(methylthio) phenyl)-2-morpholinopropanone-1 or benzophenone.
